(19) United States
(12) Patent Application Publication
(10) Pub. No.: US 2003/0051238 A1
(43) Pub. Date: Mar. 13, 2003

(54) Content rating, advisory, and profiling system for interactive television

(76) Inventor: Samuel T. Barone JR., Culver City, CA (US)

Correspondence Address: CHRISTIE, PARKER & HALE, LLP, P.O. BOX 7068, PASADENA, CA, 91109-7068, US

(21) Appl. No.: 10/222,697

(22) Filed: Aug. 16, 2002

Related U.S. Application Data
(60) Provisional application No. 60/312,835, filed on Aug. 16, 2001.

(51) Int. Cl. H04N 7/16; H04N 7/025; H04N 7/10

(52) U.S. Cl. 725/32; 725/28

(57) ABSTRACT

An interactive television (ITV) system encoding content rating, content advisories, demographics information, and other types of ITV content profiling information for an ITV content into a video program. An ITV receiver receives the encoded video program and compares the ITV content profiling information with a viewer profile stored in memory. If the profiling information for the ITV content does not match the viewer's profile, the ITV content is not provided to the viewer. For example, the ITV content is not provided if the content rating/advisory information embedded for the ITV content is greater than a rating limit set by the viewer.

### CROSS-REFERENCE TO RELATED APPLICATION(S)

The present invention claims the benefit of U.S. Provisional Application No. 60/312,835, filed on Aug. 16, 2001, the content of which is incorporated herein by reference.

### FIELD OF THE INVENTION

The present invention is generally directed to interactive television (ITV) systems and more particularly, to a system for providing rating and advisory information of ITV content transmitted with a television program.

### BACKGROUND OF THE INVENTION

Interactive television (ITV) combines conventional television with additional content (interactive content) to present a viewer with an enhanced version of a television program or commercial. As used herein, the term interactive content refers to any additional information that is used to supplement a TV signal and create an enhanced program.

Typically, the interactive content is in some way related to the television program being viewed, such as biographical information about one of the actors in the program, additional information about a topic covered in the program, and the like. If the television program is a game show, the interactive content often allows the viewer to play along with the game. For example, a viewer may answer the same questions as the contestants on the game show. The interactive content may also be associated with television commercials that a user may interact with to retrieve additional information on products and/or to purchase the products.

In order to allow a viewer to experience an enhanced television program, a television program is encoded with ITV data and broadcast to the viewers. The ITV data may take many forms, such as, for example, HTML, XML, JAVA, or JAVA Script commands. If the receiving viewer's television system is equipped with an ITV receiver, the ITV receiver may decode the embedded ITV data for accessing the associated interactive content or performing an action indicated by the command.

Today, interactive television typically depends on World Wide Web (Web) technology for delivering and viewing the enhanced content. Specific web sites, addressed with URLs, are created and maintained as ITV sites. The content in these sites may be viewed with an ITV receiver in the same way a computer browses a web site. The ITV receiver typically includes a web browser, and can display downloaded ITV content along with TV video on a conventional television set. The ITV receiver typically obtains a majority, if not all, of the ITV web content via one of the ITV web sites. The sites that are accessed and how content is displayed is determined by the ITV data contained in the video portion of the television program. One method for encoding ITV links and triggers is specified in “EIA-746-A: Transport of Internet Uniform Resource Locator Information Using Text-2 (T-2) Service,” September 1998, the content of which is incorporated herein by reference.

Given the increase of programs offering ITV content, it is desirable to provide a method to advise parents of the suitability of the ITV content for particular age groups. With respect to television programs, mechanisms exist for parents to screen such programs based on their content rating labels. For example, content rating labels used by the Motion Picture Association of America (MPAA) for rating television programs include “PG” (program suitable for all ages) “PG-13” (parental guidance for children under 13 years of age), and “R” (program restricted for children 18 years or older). Television programs also often contain content advisories describing significant types of content within the program such as violence, brief nudity, strong language, and the like. However, no similar content rating nor advisory information is provided for the ITV content provided by ITV programs. Although the content of the television program may be suitable for a particular age group, all or portions of the ITV content may not. In addition, certain types of ITV content may be better suited or preferred by people in certain demographics. Accordingly, it is desirable to provide content ratings, advisories, and other types of information for the ITV content itself.

### SUMMARY OF THE INVENTION

The present invention is directed to embedding in a video portion of a program, content ratings, content advisories, demographic information, and other types of ITV content profiling information for an ITV content. According to one embodiment, the invention is directed to a method for providing ITV content to a viewer where the method includes generating ITV data associated with a particular ITV content and generating a profile identifier for the ITV data. The ITV data and the profile identifier are then embedded into the video program. The profile identifier is used by an ITV receiver for determining whether to provide the particular ITV content to the viewer.

According to one embodiment of the invention, the profile identifier is a content rating label for rating the particular ITV content similar to the content rating label used for rating television programs.

In another embodiment, the present invention is directed to a system for providing ITV content to a viewer where the system includes a video source providing a video program and a processor generating ITV data associated with a particular ITV content. The processor associates the ITV data with a profile identifier where the profile identifier is used by an ITV receiver for determining whether to provide the particular ITV content to the viewer. An encoder coupled to the video source and the processor embeds the ITV data and the profile identifier in the video program.

In yet another embodiment, the present invention is directed to an ITV receiver including a video input receiving a video program embedded with ITV data and an associated profile identifier, a memory storing viewer profile information, and a processor coupled to the video input and the memory. The processor compares the profile identifier embedded in the video program with the viewer profile information stored in the memory for determining whether to provide an ITV content associated with the ITV data to a viewer.

It should be appreciated, therefore, that parental control may be placed on interactive content provided with an interactive television program. In addition, ITV content may be selected or filtered for a viewer based on his or her preferences and/or demographics.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 is a schematic block diagram of an ITV system allowing the integration of ITV content profiling information into a television program;

FIG. 2 is a block diagram of an exemplary ITV receiver according to one embodiment of the invention;

FIG. 3 is a flow diagram of a process undertaken by an automated encoding system for encoding ITV content profiling information into a video signal according to one embodiment of the invention; and

FIG. 4 is a flow diagram of a process undertaken by an ITV receiver for determining whether a particular ITV content should be provided to a viewer.

### DETAILED DESCRIPTION

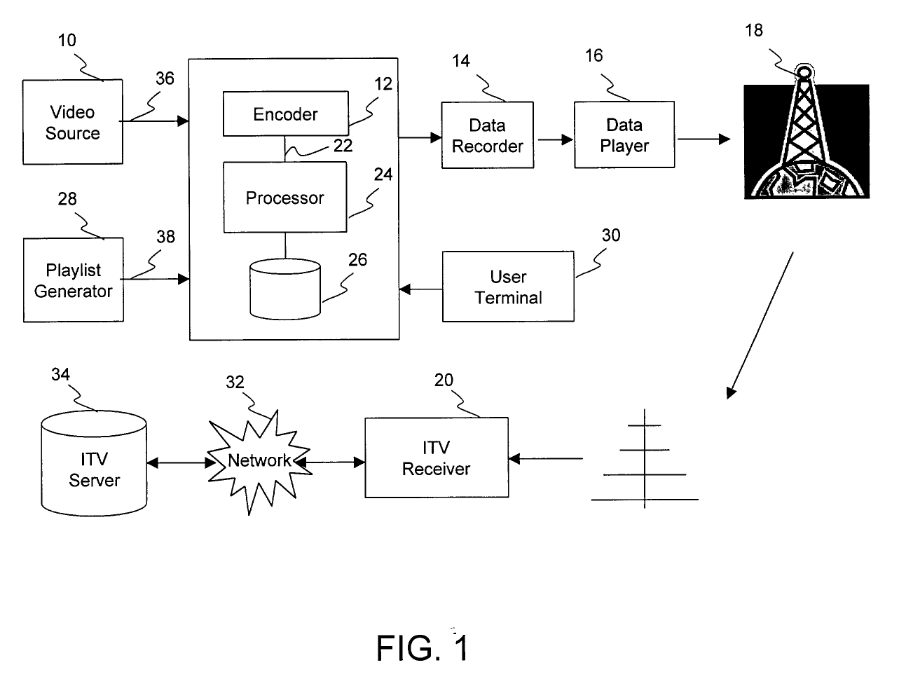

FIG. 1 is a schematic block diagram of an ITV system providing ITV content profiling information according to one embodiment of the invention. The ITV system illustrated in FIG. 1 includes an encoder 12 coupled to a video source 10 over a serial or network link 36, such as for example, a local area network (LAN) or wide area network (WAN) link. The video source 10 provides live or recorded video programs to the encoder for embedding ITV data into the video program. The ITV data may be embedded, for example, in the vertical blanking interval (VBI) (for example, line 21), or an MPEG 2 private data field (or a similar field of additional video formats) of the video portion of the program. The ITV data may be triggers, HTTP, XML, JAVA, or JAVA SCRIPT commands, URLs, and/or other type of ITV links, triggers, data sources, timing information, and data conventional in the art. According to one embodiment of the invention, the ITV data includes content rating, advisory information, content description, and/or demographics information (collectively referred to as ITV content profiling information) for the ITV content to be provided with the television program. The ITV content profiling information may be used by a viewer to filter or download certain types of ITV content based on the viewer's set profile.

The encoder 12 may be an encoder conventional in the art, such as, for example, a DV2000 universal data encoder or ITV Injector, marketed by Ultech LLC, Middlebury, Conn. The video source 10 may be a camera, VCR, betacam, DVD player, PC, CD-ROM player, or any other device capable of delivering a video feed to the encoder 12.

The ITV system illustrated in FIG. 1 further includes a processor 24 coupled to the encoder 12 over link 22. Link 22 may allow for a serial, LAN, or WAN communication between the processor 24 and encoder 12. The processor 24 may reside in a dedicated, stand-alone computer or alternatively, be incorporated into the encoder 12 or one or more ITV-related equipment.

According to one embodiment of the invention, the processor 24 receives a playlist of events from a playlist generator 28 over a serial or a private or public network link 38. The playlist generator 28 preferably generates, according to conventional mechanisms, a playlist of ITV events to be encoded into a video program. The ITV events may be used to retrieve and display particular types of ITV content on the viewer's display monitor. The ITV events may also allow a viewer to play along with a game show, purchase products, and/or make other interactions with the television program.

According to one embodiment of the invention, each ITV event is associated with a descriptor such as, for example, a start timecode, event identifier, and the like. The playlist generator 28 periodically forwards a portion of a running playlist to the processor 24. The processor reads and processes the playlist data to retrieve from a database 26 the corresponding ITV command to be encoded into the program. According to one embodiment of the invention, the ITV command is associated with ITV content profiling information identifying a suitable audience for the ITV content associated with the ITV command. An operator may define a list of playlist data and associated ITV command and ITV content profiling information, by entering records into the database 26 using a data entry program resident in a user terminal 30.

According to one embodiment of the invention, a content rating that may be included as part of the ITV content profiling information is similar to a content rating label used for television programs such as, for example, “PG,” “PG-13,” “R,” and other ratings defined by the MPAA. An ITV content advisory information that may also be provided as part of the ITV profiling information may also be similar to the content advisory information used for television programs such as, for example, “V” (violence), “BN” (brief nudity), “SL” (strong language), and other advisories defined by the MPAA. A person skilled in the art should recognize, however, that the content rating and advisory information may be any other predetermined label, phrase, or indicia, and is not limited to the ones set forth by the MPAA. In addition, the ITV content profiling information may include demographic information such as a suitable age, gender, religion, ethnic background, and the like, to which the ITV content may be targeted. The ITV content profiling information may further include description of the type of ITV content, such as, for example, gaming, community, soaps, movies, and the like.

The processor 24 feeds the ITV data to the data encoder 12 over a LAN application programming interface (API) for embedding the ITV commands and associated ITV content profiling information into the video portion of a television program. The profiling information may be encoded at different portions of the program in case a viewer tunes to the television program after the initial ITV content profiling information has been broadcast. The encoder 12 outputs the program with the encoded information to a data recorder 14 for recording for subsequent broadcast.

At an appropriate time, the video program with the embedded ITV data is broadcast via a data player 16 and a broadcast station 18. An ITV receiver 20 in a viewer's home receives and decodes the ITV data contained in the television program. The ITV receiver 20 may take the form of a set-top box, digital cable box, television with embedded set-top box functionality, or other suitable device with ITV related software, middleware, and/or hardware conventional in the art.

Upon receipt of the ITV data, the JTV receiver 20 decodes the ITV content profiling information associated with particular ITV commands embedded in different portions of the television program. The ITV content profiling information may be stand-alone triggers in the video signal of the television program or integrated with other ITV commands. The decoding preferably occurs in a manner that is transparent to the viewer. According to one embodiment of the invention, the receiver 20 drops the ITV data that is associated with ITV content profiling information that do not match or contradict a profile set by the viewer. ITV data whose ITV content profiling information match the viewer's profile are preferably passed to the run time system for retrieving the associated ITV content.

Typically, when a television program with available interactive TV content is received, the viewer is given an option to receive the enhanced experience, assuming that the ITV content profiling information matches the profile set by the viewer. In a typical scenario, if the viewer chooses the enhancements, the ITV receiver 20 establishes a connection to a network 32, such as a wide area network, cable network, wireless network, and the like, if a connection is not already made. The ITV receiver connects to an ITV server 34 based on a URL embedded in the television program, and receives ITV content from the server for producing the enhanced experience.

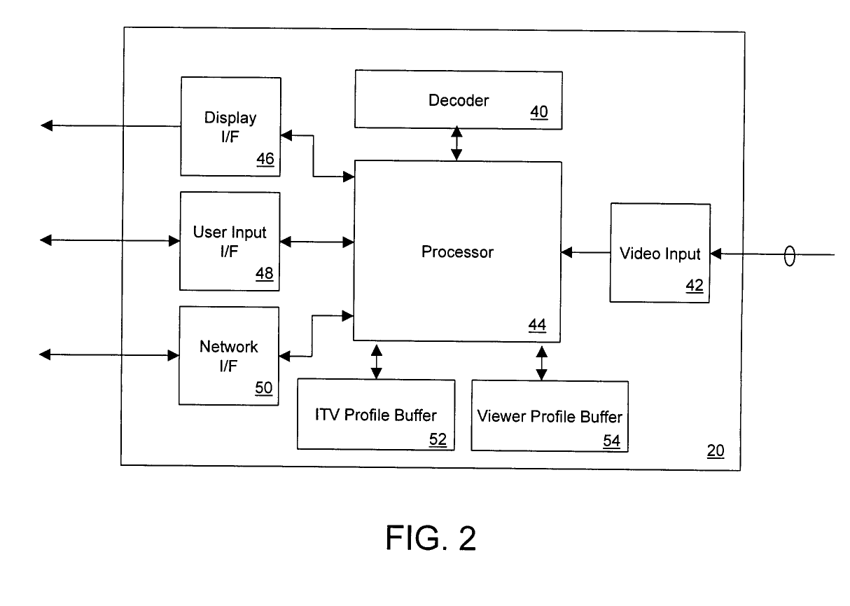

FIG. 2 is a more detailed block diagram of an exemplary ITV receiver 20 according to one embodiment of the invention. The exemplary ITV receiver 20 includes a video input 42 for receiving an ITV program broadcast from a broadcast station. The received ITV program is transmitted to an ITV processor 44 coupled to a decoder 40. Together, the ITV processor 44 and decoder 40 decode any ITV content profiling information embedded in the video program and determine whether the associated ITV content is to be provided to the viewer based on the viewer profile information stored in a viewer profile buffer 54.

According to one embodiment of the invention, ITV content profiling information is not associated with each ITV data encoded into the video signal. Rather, the system allows an assumption to be made about a current ITV data that does not include an ITV content profiling information based on the ITV content profiling information associated with prior ITV data. In this regard, the receiver 20 includes an ITV profile buffer 52 that stores a most recent ITV content profiling information decoded from the video program.

An ITV viewer interacts with the interactive program via a remote control unit, keypad, keyboard, or the like. The input provided by the user is transmitted to the ITV receiver 20 via a user input interface 48. After receipt by the ITV receiver, a user input may be transmitted to a head end or any other interested organization over a back channel via a network interface 50. The back channel may take the form of any type of communication channel known in the art, such as, for example, a telephone or a wired or wireless Internet connection. The back channel may also be used to receive ITV commands, software updates, and other types of data from the head end, an ITV producer, or the like. ITV content associated with the interactive program is provided to the viewer via the display interface 44.

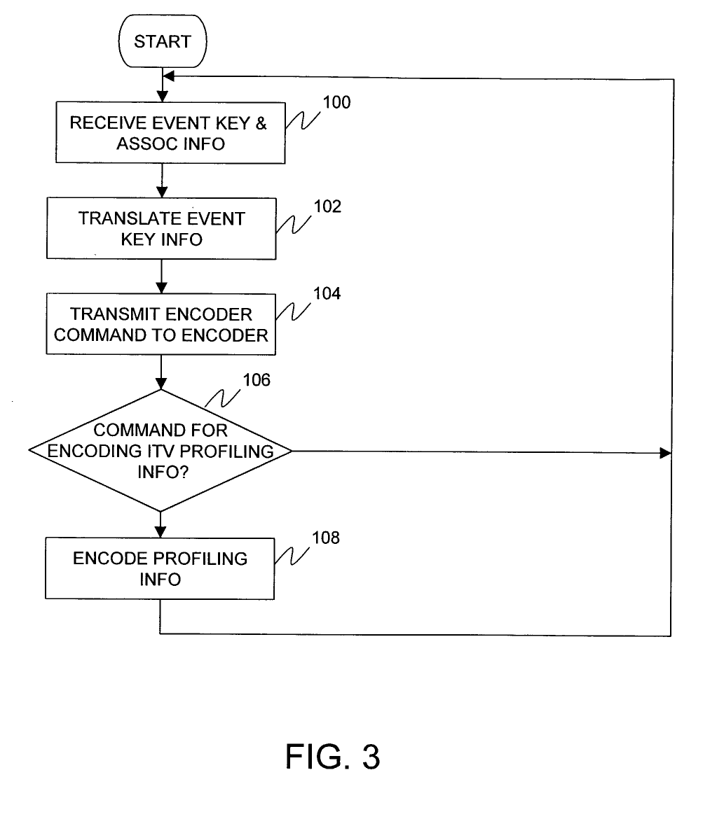

FIG. 3 is a flow diagram of a process undertaken by the processor 24 for encoding ITV content profiling information including content rating and advisory information into a video signal according to one embodiment of the invention. The playlist generator periodically forwards a portion of a running playlist to the processor 24. The playlist may include arbitrary text strings that are forwarded as serial messages to the processor. According to one embodiment of the invention, the playlist generator 38 transmits user defined text strings, referred hereto as event keys, to the processor 24. The processor 24 receives the event keys and any other associated information from the playlist generator 28 in step 100.

In step 102, the processor 24 translates the event key into an encoder command for transmitting the encoder command to the encoder 12. In this regard, the processor 24 searches for the event key in the database 26 and retrieves one or more associated encoder commands from the database. Each encoder command may include a command code and optional parameter data. The command code may indicate, for example, that content rating or content advisory information is to be encoded. The command code may then be associated with parameter data indicating a content rating label or an advisory label that is to be encoded into the video program. The parameter data may further include one or more times where the label is to be inserted in the video program, and a duration in which the rating label is to be encoded in the video program. The parameter data may be provided with an event key by the playlist generator, or may be stored in the database along with a command code.

In step 104, the encoder command and parameter data are transmitted to the encoder 12. In step 106, the encoder 12 receives the encoder command and determines if the encoder command is a command for encoding ITV content profiling information into the video program. If the answer is YES, the profiling information indicated by the command parameter data is encoded, in step 108, by the encoder 12 at the indicated time(s) of the television program and for the indicated duration.

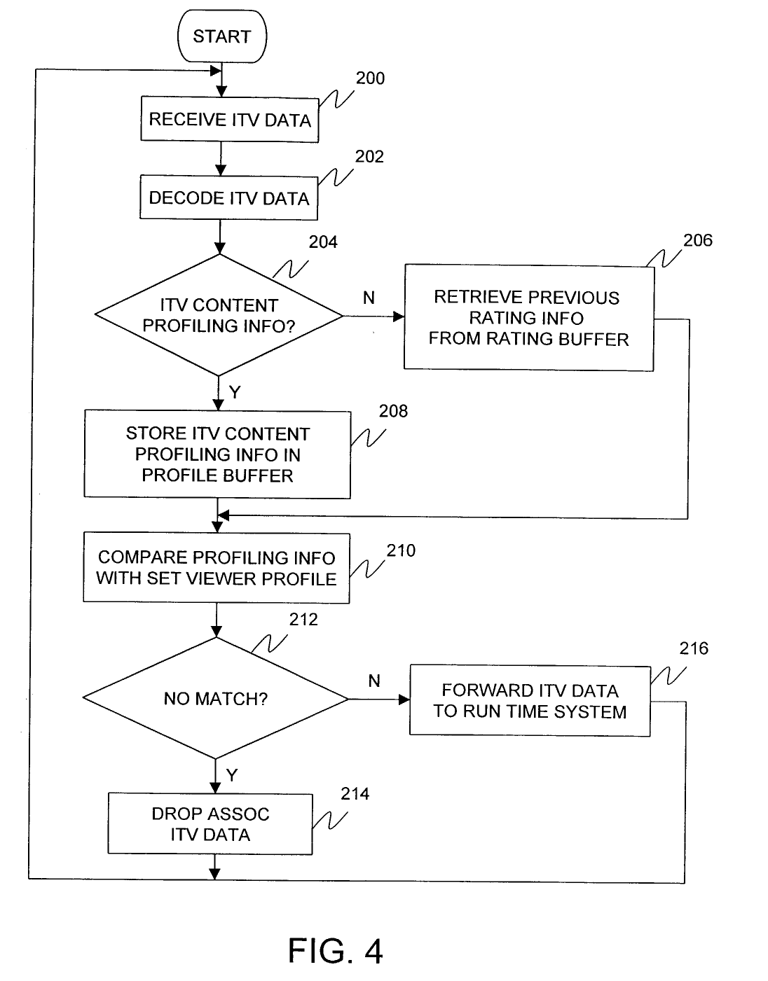

FIG. 4 is a flow diagram of a process undertaken by a viewer's ITV receiver 20 in determining whether a particular ITV content should be made available to a viewer according to one embodiment of the invention. The process starts, and in step 200, the ITV receiver 20 receives ITV data encoded in the video signal of a television program. In step 202, the ITV data is decoded by a decoder resident in the ITV receiver. In step 204, a determination is made as to whether the ITV data is ITV content profiling information. If the answer is YES, the receiver stores the ITV content profiling information in the ITV profile buffer 208. If the answer is NO, the receiver retrieves previous ITV content profiling information stored in the profile buffer and assumes that this information applies to the current ITV data.

The receiver compares either the newly stored ITV content profiling information or the ITV content profiling information previously stored in the ITV profile buffer, with a viewer profile set by the viewer. According to one embodiment of the invention, the viewer profile includes ITV content rating limits, advisory limits, and/or user demographic and/or preference information. If the ITV content profiling information does not match or contradicts the viewer profile, the receiver is configured to drop the ITV data associated with the profiling information in step 214. For example, ITV data that has a content rating or an advisory level that exceeds a rating or advisory limit set by the viewer is dropped. Otherwise, the receiver is configured to forward the ITV data to the run time system in step 216 for providing the corresponding interactive television content to the viewer. In this manner, parental control may be placed on interactive content that is provided with an interactive television program. In addition, ITV content may be selected or filtered for a viewer based on his or her preferences and/or demographics.

Although this invention has been described in certain specific embodiments, those skilled in the art will have no difficulty devising variations to the described embodiment which in no way depart from the scope and spirit of the present invention. Moreover, to those skilled in the various arts, the invention itself herein will suggest solutions to other tasks and adaptations for other applications. It is the applicants intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. A method for providing interactive television (ITV) content to a viewer, the method comprising:
generating ITV data associated with a particular ITV content;
generating a profile identifier for the ITV data, the profile identifier being used by an ITV receiver for determining whether to provide the particular ITV content to the viewer; and
embedding the ITV data and the profile identifier into the video program.

2. The method of claim 1, wherein the profile identifier is a content rating label for rating the particular ITV content.

3. The method of claim 2, wherein the content rating label is equivalent to the content rating label used for rating television programs.

4. The method of claim 1, wherein the profile identifier is demographics information.

5. The method of claim 1 wherein the embedding includes embedding the profile identifier in a plurality of portions of the video program.

6. The method of claim 1 further comprising:
receiving the video program with the embedded ITV data and profile identifier;
comparing the profile identifier with a viewer profile; and
providing the particular ITV content to the viewer or not based on the comparison.

7. A system for providing interactive television (ITV) content to a viewer, the system comprising:
a video source providing a video program;
a processor generating ITV data associated with a particular ITV content, the processor associating the ITV data with a profile identifier, the profile identifier being used by an ITV receiver for determining whether to provide the particular ITV content to the viewer; and
an encoder coupled to the video source and the processor, the encoder embedding the ITV data and the profile identifier in the video program.

8. The system of claim 7, wherein the profile identifier is a content rating label for rating the particular ITV content.

9. The system of claim 8, wherein the content rating label is equivalent to the content rating label used for rating television programs.

10. The system of claim 7, wherein the profile identifier is demographics information.

11. The system of claim 7 wherein the encoder embeds the profile identifier in a plurality of portions of the video program.

12. The system of claim 7 further comprising a receiver receiving the video program with the embedded ITV data and profile identifier, comparing the profile identifier with a viewer profile, and providing the particular ITV content to the viewer or not based on the comparison.

13. An interactive television (ITV) program receiver comprising:
a video input receiving a video program embedded with ITV data and an associated profile identifier;
a memory storing viewer profile information; and
a processor coupled to the video input and the memory, the processor comparing the profile identifier embedded in the video program with the viewer profile information stored in the memory for determining whether to provide an ITV content associated with the ITV data to a viewer.

14. The receiver of claim 13, wherein the profile identifier is a content rating label for rating the ITV content.

15. The receiver of claim 14, wherein the content rating label is equivalent to the content rating label used for rating television programs.

16. The receiver of claim 13, wherein the profile identifier is demographics information.
